(19) United States
(12) Patent Application Publication
(10) Pub. No.: US 2024/0031834 A1
(43) Pub. Date: Jan. 25, 2024

(54) SYSTEMS AND METHODS FOR MULTI-BEAM COVERAGE BY MULTIPLE COMMUNICATION NODES

(71) Applicant: Apple Inc., Cupertino, CA (US)

(72) Inventors: Mehran T. Baghaei, San Diego, CA (US); Nishant Pattanaik, San Diego, CA (US); Sudhir K. Baghel, Pleasanton, CA (US); Lohit Sarna, San Mateo, CA (US); Sudeep Bhattarai, Hayward, CA (US); Seshu Tummala, Cupertino, CA (US); Venkateswara Rao Manepalli, San Jose, CA (US)

(21) Appl. No.: 17/871,606

(22) Filed: Jul. 22, 2022

(51) Int. Cl. H04W 24/04; H04W 56/00; H04B 7/0408

(52) U.S. Cl. CPC H04W 24/04; H04W 56/001; H04B 7/0408

(57) ABSTRACT

An electronic device includes a transceiver and processing circuitry communicatively coupled to the transceiver and configured to transmit uplink signals to a secondary communication node in response to determining that an uplink beam of a primary communication node is non-functional while continuing to receive downlink signals from the primary communication node using a downlink beam. Using multi-beam coverage by multiple communication nodes provide more reliable communications for the electronic device when a beam of a communication node is non-functional.

### BACKGROUND

The present disclosure relates generally to wireless communication, and more specifically to wireless signals beams transmitted by communication nodes.

User equipment (e.g., mobile communication device) may transmit and receive wireless signals (e.g., carrying user data) with a communication hub (e.g., a gateway, a base station, or a network control center) via a communication node (e.g., a non-terrestrial station, a satellite, and/or a high-altitude platform station). For instance, the communication hub may transmit a wireless “hub” signal to the communication node, and the communication node may relay the hub signal to the user equipment via a downlink beam. The user equipment may transmit a user signal to the communication node via an uplink beam, and the communication node may relay the user signal to the communication hub. However, using the same communication node to relay the hub and user signals may cause issues when the uplink beam becomes non-functional. For example, the user signal may be discarded or lost without reaching the communication hub because the communication node may not relay the user signal to the communication hub via the non-functional uplink beam. In some emergency cases (e.g., accidents, natural disasters), the discarded or lost user signals may cause delayed actions in response to the emergencies.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, user equipment includes one or more antennas, a transmitter and a receiver each coupled to the one or more antennas, and processing circuitry configured to cause the receiver to receive communication node pairing information, receive a first indication that an uplink beam of a primary communication node is non-functional based on the communication node pairing information, receive a second indication that a secondary communication node is accessible based on the communication node pairing information and the first indication, cause the transmitter to transmit transmission signals to the secondary communication node, and cause the receiver to receive reception signals from the primary communication node.

In another embodiment, a non-transitory, computer-readable medium includes instructions that, when executed by processing circuitry, cause the processing circuitry to receive communication node pairing information associated with a primary communication node paired with a secondary communication node, synchronize with the primary communication hub to receive reception signals from the primary communication hub in a first communication cycle, receive, for a second communication cycle, a first indication of that an uplink beam of the primary communication node is non-functional based on the communication node pairing information, receive a second indication of whether the secondary communication node is accessible based on the communication node pairing information and the first indication; and synchronize with the secondary communication node to transmit transmission signals to the secondary communication node based on the second indication in the second communication cycle.

In yet another embodiment, an electronic device includes a transceiver and processing circuitry communicatively coupled to the transceiver and configured to receive communication node pairing information associated with a primary communication node paired with a secondary communication node, receive a location of the electronic device, cause the transceiver to synchronize with the primary communication node to receive reception signals from the primary communication node for a first communication cycle, receive a beam identifier corresponding to an uplink beam of the primary communication node based on the reception signals, receive a first indication that the uplink beam of the primary communication node is non-functional based on the beam identifier and the communication node pairing information, receive a second indication that the secondary communication node is accessible based on the communication node pairing information and the location of the electronic device based on the first indication, and cause the transceiver to synchronize with the secondary communication node for the second communication cycle to transmit transmission signals to the secondary communication node based on the second indication.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of user equipment, according to embodiments of the present disclosure;

FIG. 2 is a functional diagram of the user equipment of FIG. 1, according to embodiments of the present disclosure;

FIG. 3 is a schematic diagram of a communication system including the user equipment of FIG. 1, according to embodiments of the present disclosure;

FIG. 4 is a schematic diagram of circuitry of the user equipment of FIG. 1, according to embodiments of the present disclosure;

FIG. 5 is a schematic diagram of a communication system using one communication node for signal transmissions with the user equipment of FIG. 1, according to embodiments of the present disclosure;

FIG. 6 is a schematic diagram of a communication system using two communication nodes for signal transmissions with the user equipment of FIG. 1, according to embodiments of the present disclosure;

FIG. 7 is a schematic diagram of the communication system of FIG. 6 using multi-beam coverage for signal transmissions with the user equipment of FIG. 1, according to embodiments of the present disclosure; and

FIG. 8 is a flowchart of a method for communicating with the user equipment of FIG. 1 using multi-beam coverage by multiple communication nodes, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to facilitating communication between a mobile communication device (e.g., user equipment) and a communication hub (e.g., a gateway, a base station, or a network control center) using multiple beams from multiple communication nodes. The user equipment may include a cell phone, a personal digital assistance device, or any other suitable device used to receive or transmit signals. The signals may include or be associated with various forms of communication emergency text messaging, emergency voice calling, acknowledgement messaging, video streaming, internet browsing, and so forth. The communication nodes may include multiple non-terrestrial stations, satellites, high-altitude platform stations, and so on. In particular, the communication nodes may facilitate signal transmissions between the user equipment and the communication hub. For example, the user equipment may use one of the communication nodes (e.g., a primary communication node) for bi-directional communication by relaying the signal transmissions from the user equipment to the communication hub via the primary communication node, and vice versa.

The primary communication node may emit multiple forward beams (e.g., beams that transmit downlink signals to the user equipment) and multiple reverse beams (e.g., beams that receive uplink signals from the user equipment). In some cases, a reverse beam of the primary communication node may become non-functional (e.g., due to a receiver of the primary communication node being non-functional). As a result, the primary communication node may not successfully receive a signal transmitted from the user equipment. In response to determining that the reverse beam of the primary communication node is non-functional, the user equipment may switch to a different (e.g., a secondary) communication node (e.g., to facilitate the signal transmissions to the communication hub). The secondary communication node may be paired with the primary communication node based on a configuration process that may provide pairing information. Using the secondary communication node paired with the primary communication node may mitigate issues caused by the non-functional reverse beam of the primary communication node and avoid potential signal transmission failure between the user equipment and the communication hub.

In particular, the primary communication node may still transmit the downlink signals to the user equipment, while the secondary communication node may receive the uplink signals from the user equipment. Accordingly, the configuration process may include pairing communication nodes. The pairing information (e.g., communication hub identifiers, beam identifiers) may be received by the user equipment (e.g., when the user equipment is communicatively coupled to a communication network, such as the Internet). For example, the user equipment may receive or update the pairing information from the communication network based on a specific time interval or periodicity (e.g., a day, a week).

In existing approaches, the user equipment may transmit and re-transmit different signals at different communication cycles. In the disclosed embodiments, at each communication cycle, the user equipment may use the pairing information and other information (e.g., current location of the user equipment) to 1) determine whether a reverse beam of the primary communication node to which the user equipment initially establishes a connection in the next communication cycle is determined non-functional; 2) if the reverse beam is determined non-functional, determine the secondary communication node paired with the primary communication node for receiving the uplink signals from the user equipment and transmitting the uplink signals to the communication hub; 3) determine a reverse beam of the secondary communication node to be used for receiving the uplink signals from the user equipment; and/or 4) determine time delay and frequency Doppler for the reverse beam of the secondary communication node.

Embodiments herein provide various apparatuses and techniques to use multiple communication beams from multiple communication nodes to enable user equipment to transmit wireless signals to a communication hub. In some embodiments, the user equipment may determine a relative positioning between the user equipment and the secondary communication node. For instance, the relative positioning may include an elevation angle, and the user equipment may determine whether a reverse beam of the secondary communication node is accessible or visible based on the elevation angle. In response to a determination that the reverse beam of the secondary communication node is not accessible or visible, the user equipment may use a different reverse beam (e.g., an adjacent beam with respect to the non-functional beam) of the primary communication node to re-transmit the signal to the primary communication node for the subsequent transmission to the communication hub.

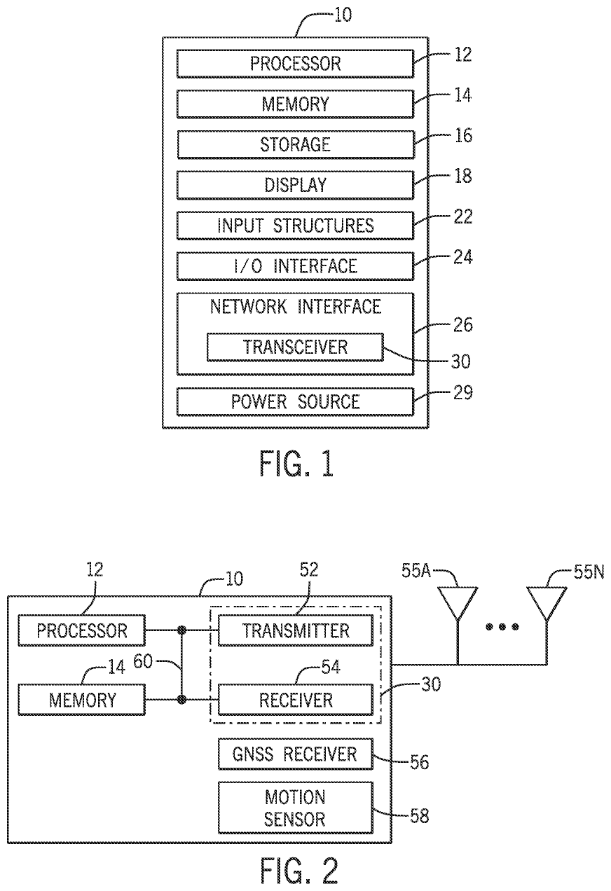

FIG. 1 is a block diagram of user equipment 10 (e.g., an electronic device or a mobile communication device), according to embodiments of the present disclosure. The user equipment 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, the memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the user equipment 10.

By way of example, the user equipment 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be generally referred to herein as “data processing circuitry.” Such data processing circuitry may be embodied wholly or in part as software, hardware, or both. Furthermore, the processor 12 and other related items in FIG. 1 may be a single contained processing module or may be incorporated wholly or partially within any of the other elements within the user equipment 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein. The processors 12 may perform the various functions described herein.

In the user equipment 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the user equipment 10 to provide various functionalities.

In certain embodiments, the display 18 may facilitate users to view images generated on the user equipment 10. In some embodiments, the display 18 may include a touch screen, which may facilitate user interaction with a user interface of the user equipment 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the user equipment 10 may enable a user to interact with the user equipment 10 (e.g., pressing a button to increase or decrease a volume level). The I/O interface 24 may enable the user equipment 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol.

The network interface 26 may include, for example, one or more interfaces for a peer-to-peer connection, a personal area network (PAN), such as an ultra-wideband (UWB) or a BLUETOOTH® network, for a local area network (LAN) or wireless local area network (WLAN), such as a network employing one of the IEEE 802.11x family of protocols (e.g., WI-FIC®), and/or for a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, New Radio (NR) cellular network, 6^{th} generation (6G) cellular network and beyond, a satellite connection (e.g., via a satellite network), and so on. In particular, the network interface 26 may include, for example, one or more interfaces for using a Release-15 cellular communication standard of the 5G specifications that include the millimeter wave (MM Wave) frequency range (e.g., 24.25-300 gigahertz (GHz)). The network interface 26 of the user equipment 10 may allow communication over the aforementioned networks (e.g., 5G, Wi-Fi, LTE-LAA, and so forth). The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, UWB network, alternating current (AC) power lines, and so forth. The network interface 26 may, for instance, include a transceiver 30 for communicating signals using one of the aforementioned networks. The power source 29 of the user equipment 10 may include any suitable source of power, such as a rechargeable lithium polymer (Li-poly) battery and/or an alternating current (AC) power converter.

FIG. 2 is a functional diagram of the user equipment 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55), and/or a global navigation satellite system (GNSS) receiver 56 may be communicatively coupled directly or indirectly (e.g., through or via another component, a communication bus, a network) to one another to transmit and/or receive signals between one another.

The user equipment 10 may include the transmitter 52 and/or the receiver 54 that respectively transmit and receive signals between the user equipment 10 and an external device via, for example, a network (e.g., including base stations) or a direct connection. As illustrated, the transmitter 52 and the receiver 54 may be combined into the transceiver 30. The user equipment 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with a one or more beams and various configurations. In some embodiments, multiple antennas of the antennas 55A-55N of an antenna group or module may be communicatively coupled a respective transceiver 30 and each emit radio frequency signals that may constructively and/or destructively combine to form a beam. The user equipment 10 may include multiple transmitters, multiple receivers, multiple transceivers, and/or multiple antennas as suitable for various communication standards. For example, the user equipment 10 may include a first transceiver to send and receive messages using a first wireless communication network, a second transceiver to send and receive messages using a second wireless communication network, and a third transceiver to send and receive messages using a third wireless communication network, though any or all of these transceivers may be combined in a single transceiver. In some embodiments, the transmitter 52 and the receiver 54 may transmit and receive information via other wired or wireline systems or means.

The user equipment 10 may include the GNSS receiver 56 that may enable the user equipment to receive GNSS signals from a GNSS network that includes one or more GNSS satellites or GNSS ground stations. The GNSS signals may include a GNSS satellite's observation data, broadcast orbit information of tracked GNSS satellites, and supporting data, such as meteorological parameters, collected from co-located instruments of a GNSS satellite. For example, the GNSS signals may be received from a Global Positions System (GPS) network, a Global Navigation Satellite System (GLONASS) network, a BeiDou Navigation Satellite System (BDS), a Galileo navigation satellite network, a Quasi-Zenith Satellite System (QZSS or Michibiki) and so on. The GNSS receiver 56 may process the GNSS signals to determine a global position of the user equipment 10.

The user equipment 10 may include one or more motion sensors 58 (e.g., as part of the input structures 22). The one or more motion sensors (collectively referred to as “a motion sensor 58” herein) may include an accelerometer, gyroscope, gyrometer, and the like, that detect and/or facilitate determining a current location of the user equipment, an orientation (e.g., including pitch, yaw, roll, and so on) and/or motion of the user equipment 10, a relative positioning (e.g., an elevation angle) between the user equipment a communication node.

As illustrated, the various components of the user equipment 10 may be coupled together by a bus system 60. The bus system 60 may include a data bus, for example, as well as a power bus, a control signal bus, and a status signal bus, in addition to the data bus. The components of the user equipment 10 may be coupled together or accept or provide inputs to each other using some other mechanism.

As discussed above, the user equipment 10 may transmit a signal directed to a communication node for subsequent transmission to a communication hub. For example, the user equipment 10 may transmit different signals at a transmission power to enable successful receipt of the signals by the communication node. However, in response to a determination that the communication node does not successfully receive the signal (e.g., due to a non-functional reverse beam), the user equipment 10 may switch to a second communication node and re-transmit the signal to the second communication node, such as until the user equipment 10 determines that the second communication node successfully receives the signal (e.g., in response to receipt of an acknowledgement signal from the second communication node).

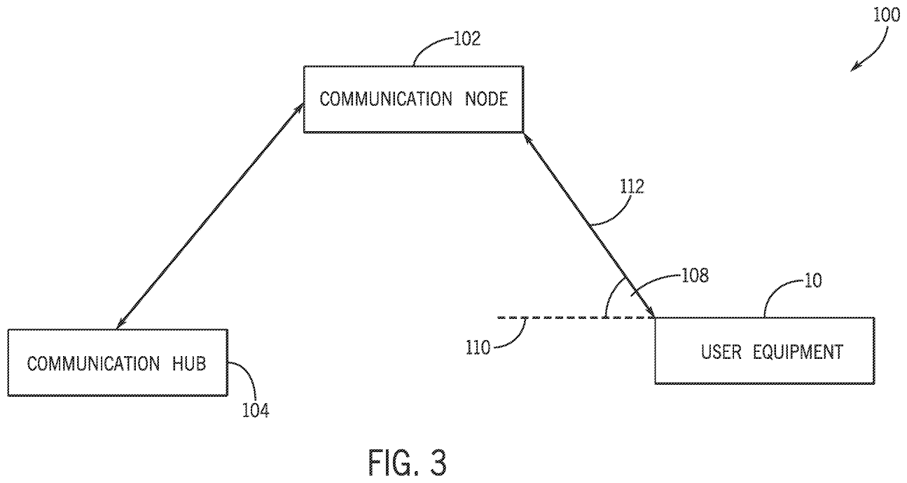

With the preceding in mind, FIG. 3 is a schematic diagram of a communication system 100 including the user equipment 10, according to embodiments of the present disclosure. The communication system 100 includes a communication node 102, which may include base stations, such as Next Generation NodeB (gNodeB or gNB) base stations that provide 5G/NR coverage to the user equipment 10, Evolved NodeB (eNodeB) base stations and may provide 4G/LTE coverage to the user equipment 10, and so on. Additionally or alternatively, the communication node 102 may include non-terrestrial base stations, high altitude platform stations, airborne base stations, space borne base stations, satellites (e.g., a low earth orbit satellite, a medium earth orbit satellite, a geosynchronous equatorial orbit satellite, a high earth orbit satellite), or any other suitable nonstationary communication devices, communicatively coupled to the user equipment 10. The communication node 102 may be communicatively coupled to a communication hub 104, such as another electronic device, a terrestrial base station, a ground station, a call center, and so forth, to enable communication of signals between the communication hub 104 and the user equipment 10. For example, the user equipment 10, using its transceiver 30, may transmit a signal to the communication node 102, and the communication node 102 may forward the signal to the communication hub 104. Additionally or alternatively, the communication hub 104 may transmit a signal to the communication node 102, and the communication node 102 may forward the signal to the user equipment 10 for receipt, using its transceiver In some embodiments, the transceiver 30 may include a software-defined radio that enables communication with the communication node 102. For example, the transceiver 30 may be capable of communicating via a first communication network (e.g., a cellular network), and may be capable of communicating via a second communication network (e.g., a non-terrestrial network) when operated by software (e.g., stored in the memory 14 and/or the storage 16 and executed by the processor 12).

The user equipment 10 may also determine whether the communication node 102 successfully receives a signal transmitted by the user equipment 10. For example, the communication node 102 may transmit an acknowledgement signal toward the user equipment 10 in response to receiving the signal from the user equipment 10. In response to receiving an acknowledgement signal from the communication node 102, such as via the transceiver 30 (e.g., the receiver 54), after (e.g., within a duration of time of) transmitting the signal to the communication node 102, the user equipment 10 may determine that the communication node 102 successfully receives the signal. However, in response to determining that an acknowledgment signal from the communication node 102 was not received after (e.g., within the duration of time of) transmitting the signal to the communication node 102, the user equipment 10 may determine that the communication hub node did not successfully receive the signal. As a result, the user equipment may re-transmit the signal toward the communication node 102.

However, the process described above may result in a delay in signal transmission (e.g., due to re-transmitting the signal). Alternatively, the communication node 102 may use communication node information received prior to the signal transmission to determine whether the communication node 102 is capable of receiving the signal transmitted by the user equipment 10. For example, the communication node 102 may receive the communication node information based on a specific time interval (e.g., a day, a week) from another component or system (e.g., a communication network). The component or system may be configured to provide the communication node information (e.g., position or orbit information, communication node identifiers, beam identifiers) associated with the communication node 102 and other relevant communication nodes (e.g., a second communication node paired with the communication node 102). Based on the communication node information and other relevant information (e.g., location information of the user equipment 10), the user equipment 10 may determine that a reverse beam of the communication node 102 used to receive the signal from user equipment 10 is non-functional. As such, the user equipment 10 may switch to the second communication node paired with the communication node 102 or use a different reverse beam (e.g., another reverse beam adjacent to the non-functional reverse beam) of the communication node 102 for the signal transmission.

In some embodiments, the user equipment 10 may determine or receive an indication of communication quality based on a relative positioning between a communication node (e.g., the communication node 102 and/or a second communication node paired with the communication node 102) and the user equipment 10. For this reason, the user equipment 10 may utilize data from a variety of data sources to determine the relative positioning. For example, the user equipment 10 may use ephemeris data downloaded from a network (e.g., the Internet) and stored in the memory 14 to determine a location of the communication node. The ephemeris data may include various operating parameters that may be associated with movement (e.g., orbital location, orientation) of the communication node, movement of the Earth (e.g., a gravitational property, an orbit of the Earth), a historical positioning of the communication node, and the like. The user equipment 10 may also use the GNSS receiver 56 to receive GNSS signals that include observation data, broadcast orbit information, and supporting data associated with the GNSS satellites to determine a location of the user equipment 10. Additionally, the user equipment 10 may use orientation data received from the motion sensor 58 to determine an orientation of the user equipment 10. Based on the location of the communication node, the location of the user equipment 10, and the orientation of the user equipment 10, the processor 12 may determine the relative positioning between the communication node and the user equipment 10.

As an example, the processor 12 may determine an elevation angle 108 of the communication node 102 relative to the user equipment 10. The elevation angle 108 may include an angle spanning between a horizon 110 and a line of sight 112 between the communication hub 102 and the user equipment 10. The elevation angle 108 may be indicative of a potential communication quality between the communication hub 102 and the user equipment 10. For example, a greater elevation angle 108 (e.g., an angle closer to 90 degrees, such as between 80 and 90 degrees, between 70 and 90 degrees, between 60 and degrees, between 45 and 90 degrees, between 30 and 90 degrees, and so on) may indicate potentially reduced obstruction or interference (e.g., by a building, by foliage, by signals transmitted via other devices) of the line of sight 112, and therefore indicate potentially improved communication quality. A smaller elevation angle 108 (e.g., an angle closer to 0 degrees, such as between 0 and 10 degrees, between 0 and 20 degrees, between 0 and 30 degrees, between 0 and 45 degrees, and so on) may indicate potentially increased obstruction of the line of sight 112 and therefore indicate potentially reduced communication quality.

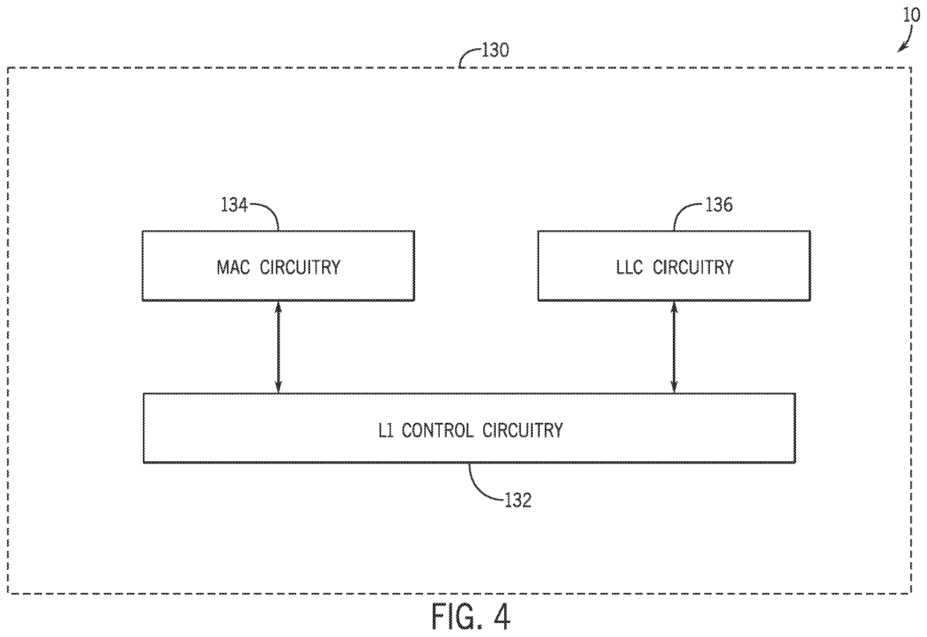

FIG. 4 is a schematic diagram of circuitry 130 of the user equipment 10. The circuitry 130 may include Layer 1 (L1) control circuitry 132 (e.g., a physical layer controller), media access control (MAC) circuitry 134, and logic link control (LLC) circuitry 136. Each of the MAC circuitry 134 and the LLC circuitry 136 may be communicatively coupled to the L1 control circuitry 132. For example, the L1 control circuitry 132 may operate based on information (e.g., the communication node information, the location and orientation of the user equipment 10) received from the MAC circuitry 134 and/or the LLC circuitry 136. While the term circuitry (e.g., hardware) is used to describe the L1 control circuitry 132, the MAC circuitry 134, and the LLC circuitry 136, it should be understood that any or all of these circuitries may be implemented in whole or in part by software (e.g., instructions executable by the processor 12) or logic (e.g., a combination of hardware and software).

In some embodiments, the L1 control circuitry 132 may cause the transceiver 30 to transmit a signal via a functional reverse beam of a communication node 102 based on the information received from the MAC circuitry 134 and/or the LLC circuitry 136. For example, the MAC circuitry 134 may process data and communicate with the L1 control circuitry 132 to indicate that the data is to be transmitted by the user equipment 10 (e.g., as a signal) to the communication node 102. Moreover, the MAC circuitry 134 may provide information (e.g., a data frame) indicating a quantity of times the data or a signal having the data has been previously transmitted or re-transmitted. For example, the information may include a datagram number or value that indicates the quantity of times the data has been previously transmitted. Each time the data is to be re-transmitted, the datagram number may be increased (e.g., by a value of one) to indicate the quantity of previous transmissions. Furthermore, the LLC circuitry 136 may provide information indicating the elevation angle 108 of the communication node 102 relative to the user equipment 10. In some embodiments, the LLC circuitry 136 may provide such information to the L1 control circuitry 132 at a predetermined frequency or cycle. Thus, the L1 control circuitry 132 may continually receive information regarding the elevation angle 108 from the LLC circuitry 136 and may readily utilize updated information regarding the elevation angle 108 when the L1 control circuitry 132 is to cause the transceiver 30 to transmit the data (e.g., in a radio frequency signal).

The L1 control circuitry 132 may determine an identifier (e.g., identification information) of the reverse beam of the communication node 104 based on the information provided by the MAC circuitry 134 and/or the LLC circuitry 136. As an example, the L1 control circuitry 132 may determine whether a reverse beam of a communication node 102 (e.g., a primary communication node) currently in use is functional. The L1 control circuitry 132 may look into the information provided by the circuitry 134 and/or the LLC circuitry 136 to determine an identifier of the reverse beam of the primary communication hub. Based on the identifier of the reverse beam, the L1 control circuitry 132 may determine that the reverse beam is non-functional (e.g., at the next communication cycle). As such, the L1 control circuitry 132 may determine an identifier of a reverse beam of a different communication node (e.g., a secondary communication node) paired with the primary communication node based on the information provided by the MAC circuitry 134 and/or the LLC circuitry 136. Using the identifier of the reverse beam of the secondary communication node, the L1 control circuitry 132 may cause the transceiver 30 to transmit a signal via the reverse beam of the secondary communication node.

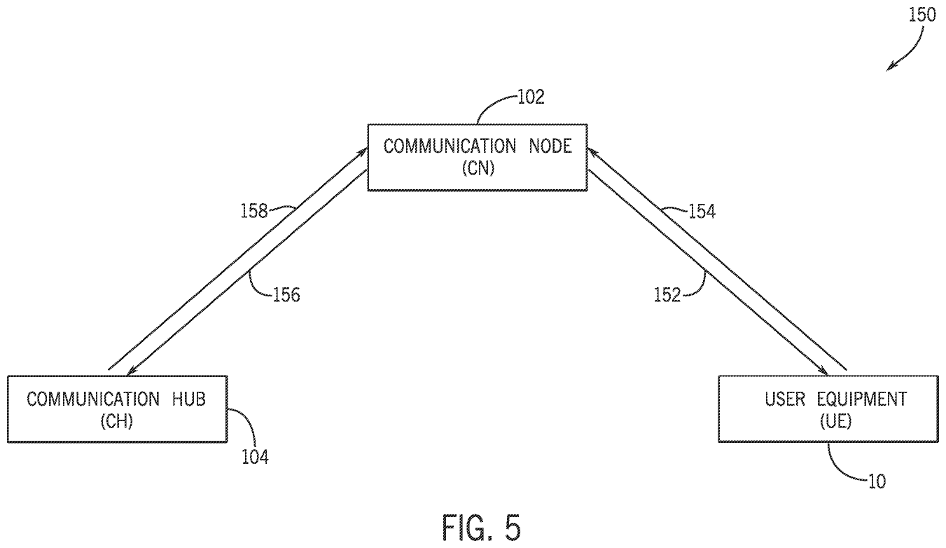

With the foregoing in mind, FIG. 5 is a schematic diagram of a communication system 150 using the communication node 102 for signal transmissions with the user equipment 10 of FIG. 1, according to embodiments of the present disclosure. The communication system 150 may include the user equipment the communication node 102, and the communication hub 104. At each communication cycle, the user equipment 10 may synchronize to the communication node 102 to establish a connection for bi-directional communication. For example, the user equipment 10 may transmit an uplink signal to the communication node 102 via a beam 152 (e.g., a reverse beam that receives the uplink signal), and receive a downlink signal from the communication node 102 via a beam 154 (e.g., a forward beam that transmits the downlink signal to the user equipment 10). The communication node 102 may also synchronize to the communication hub 104 to establish a connection for bi-direction communication. For example, the communication node 102 may relay the uplink signal to the communication hub 104 via a beam 156 (e.g., a communication-node-to-communication-hub beam), and receive a communication hub signal (e.g., a signal in response to the uplink signal sent from the user equipment 10) from the communication hub 104 via a beam 158 (e.g., a communication-hub-to-communication-node beam).

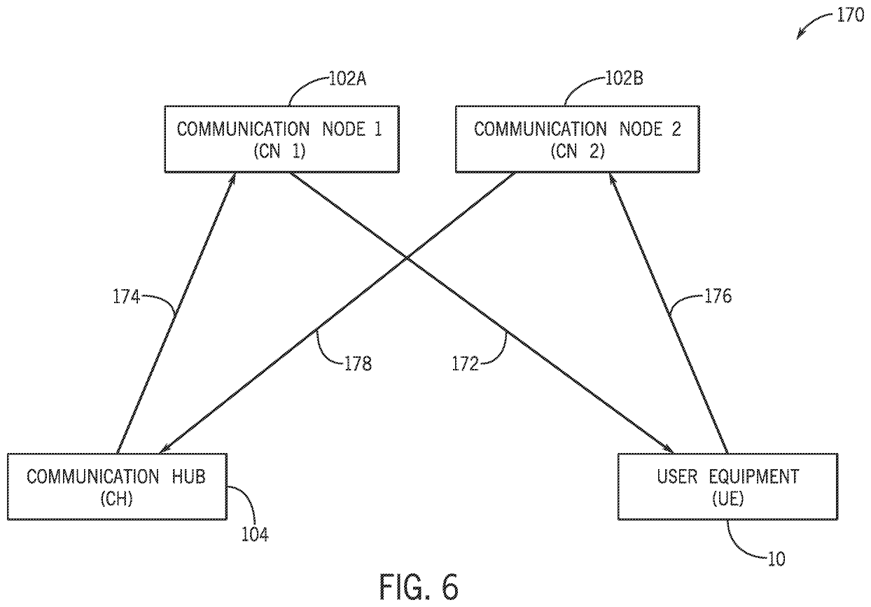

In some cases, certain issues (e.g., aging of the communication node 102, obstructions, interferences, and so on) may cause the beam 152 to become non-functional. As a result, the uplink signal may not reach the communication node 102. To prevent a signal transmission failure associated with the uplink signal, the user equipment 10 may switch to a second communication node to transmit the uplink signal that may reach the communication hub 104 via the second communication node. FIG. 6 is a schematic diagram of a communication system 170 using two communication nodes for signal transmissions with the user equipment 10 of FIG. 1, according to embodiments of the present disclosure.

The communication system 170 may include the user equipment (UE) 10, a primary communication node (CN 1) 102A, a secondary communication node (CN 2) 102B, and the communication hub (CH) 104. At a communication cycle, the user equipment 10 may synchronize to the primary node 102A to establish a connection for receiving a downlink signal from the primary communication node 102A via a beam 172. The downlink signal may correspond to a communication hub signal transmitted from the communication hub 104 to the primary communication node 102A via a beam 174. However, the user equipment 10 may determine that a reverse beam of the primary communication node 102A is non-functional and that the reverse beam is to be used for relaying an uplink signal from the user equipment 10 to the communication hub 104. To prevent a loss of the uplink signal, the user equipment 10 may use the secondary communication node 102B to receive the uplink signal via a beam 176 and relay the uplink signal to the communication hub 104 via a beam 178.

Using the process described above, the primary communication node 102A may still receive the communication hub signal from the communication hub 104 and transmit the downlink signal to the user equipment 10, while the secondary communication node 102B may receive the uplink signal from the user equipment 10 and relay the uplink signal to the communication hub 104. A communication node pairing between the primary communication node 102A and the secondary communication node 102B may be performed as part of a configuration process. The configuration process may provide pairing information (e.g., communication node identifiers and beam identifiers associated with the communication nodes 102A and 102B) that may be received by the user equipment 10. For example, when the user equipment 10 is communicatively coupled to a communication network (e.g., the Internet), the user equipment 10 may receive or (e.g. by downloading) the pairing information. The user equipment 10 may update the pairing information based on a specific time interval (e.g., a day, a week) and/or based on a location of the user equipment 10.

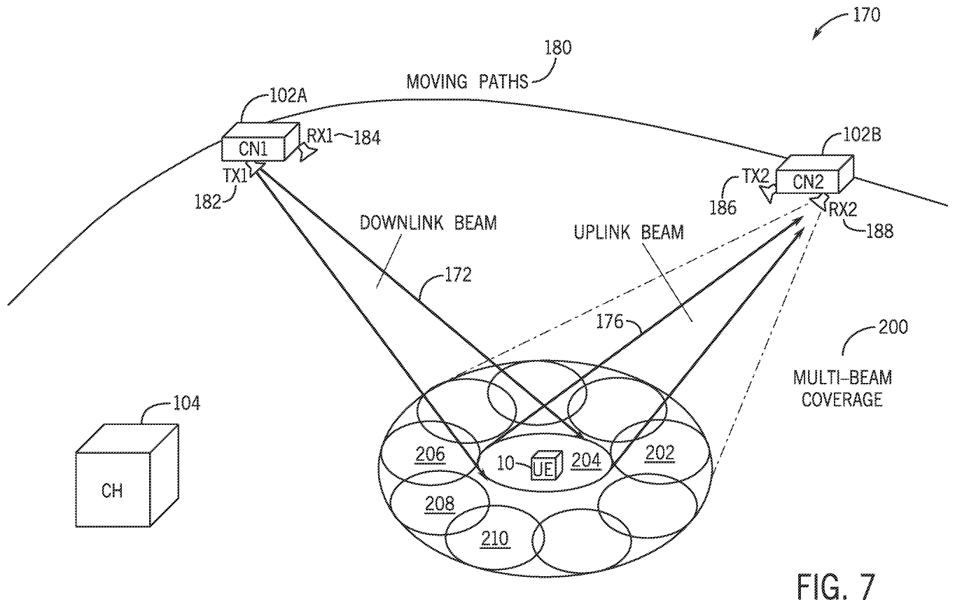

FIG. 7 is a schematic diagram of the communication system 170 of FIG. 6 using multi-beam coverage for signal transmissions with the user equipment 10 of FIG. 1, according to embodiments of the present disclosure. As illustrated, the primary communication node 102A and the secondary communication hub 102B node move along one or more moving paths 180 (e.g., orbits of the Earth). The primary communication node 102A may include a transmitter (TX 1) 182 and a receiver (RX 1) 184. The secondary communication node 102B may include a transmitter (TX 2) 186 and a receiver (RX 2) 188. The primary communication node 102A and the secondary communication node 102B may utilize corresponding transmitters 182, 186 and receivers 184, 188 to emit multiple beams (e.g., forward beams that transmit downlink signals, reverse beams that receive uplink signals) covering same or different areas. For example, the secondary communication node 102B may have a multi-beam coverage 200 within which the secondary communication node 102B may receive an uplink signal using a beam (e.g., an uplink beam 176) of the reverse beams emitted by the secondary communication node 102B. Each of the reverse beams may cover an area (e.g., area 202, 204, 206, 208, 210, and so on) on the surface of the Earth.

Although the FIG. 7 illustrates the multi-beam coverage 200 corresponding to the reverse beams emitted by the secondary communication node 102B, it should be noted that different multi-beam coverages may be used to establish different connections between the user equipment 10 and the primary communication node 102A or the secondary communication node 102B. For example, such connections may enable the user equipment 10 to receive a downlink signal from the primary communication node 102B using the downlink beam 172.

At a communication cycle (e.g., cycle N), the user equipment 10 may move (e.g., by a user) to the area 204 covered by the downlink beam 172, such that the user equipment 10 may receive the downlink signal from the primary communication node 102A. However, the user equipment 10 may determine that a reverse beam of the primary communication node 102A is non-functional for cycle N+1 based on preset or predetermined information and/or data (e.g., the communication node information downloaded from a communication network and stored in the memory 14 and/or the storage 16), such that the user equipment 10 may be unable to use the reverse beam to transmit an uplink signal to the of the primary communication node 102A. To avoid a signal transmission failure, the user equipment 10 may utilize the preset or predetermined information and/or data to determine a different reverse beam (e.g., the uplink beam 176) of the secondary communication node 102B that is capable of transmitting the uplink signal to the secondary communication node 102B, which may relay the uplink signal to the communication hub 104. In some embodiments, the user equipment 10 may determine that the secondary communication node 102B is not visible based on a relative positioning (e.g., the elevation angle) between the user equipment 10 and the secondary communication hub 102B. In such cases, the user equipment 10 may use another reverse beam adjacent to the non-functional reverse beam of the primary communication 102A to transmit the uplink signal.

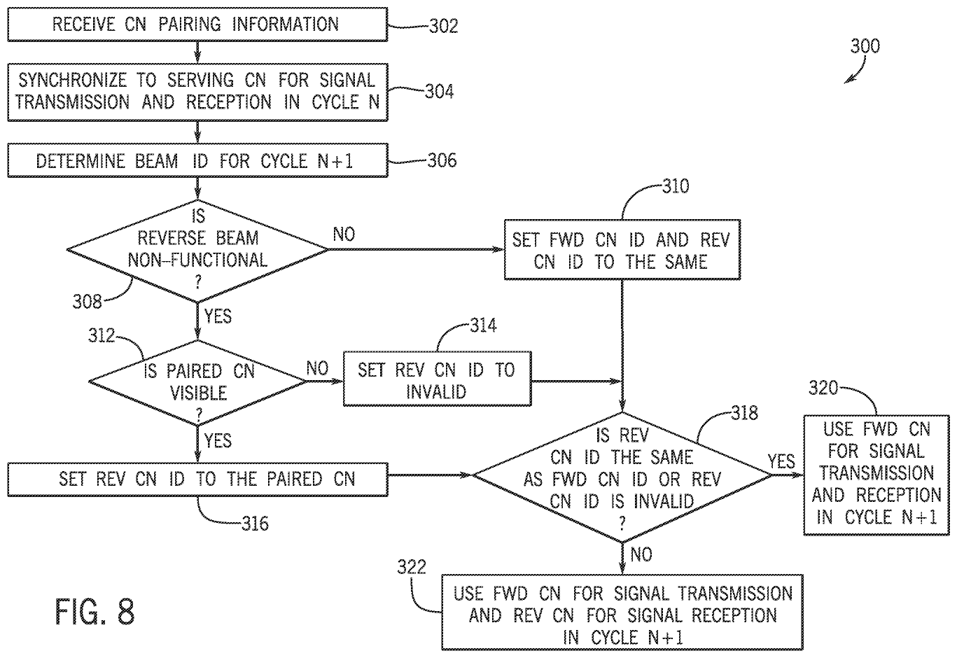

With the preceding in mind, FIG. 8 is a flowchart of a method 300 for communicating with the user equipment 10 of FIG. 1 using multi-beam coverage by multiple communication nodes, according to embodiments of the present disclosure. Any suitable device (e.g., a controller) that may control components of the user equipment 10, such as the processor 12, may perform the method 300. In some embodiments, the method 300 may be implemented by executing instructions stored in a tangible, non-transitory, computer-readable medium, such as the memory 14 or storage 16, using the processor 12. For example, the method 300 may be performed at least in part by one or more software components, such as an operating system of the user equipment 10, one or more software applications of the user equipment 10, and the like. While the method 300 is described using steps in a specific sequence, it should be understood that the present disclosure contemplates that the described steps may be performed in different sequences than the sequence illustrated, and certain described steps may be skipped or not performed altogether.

Before the user equipment 10 initiates signal communication, at block 302, the user equipment 10 receives communication node pairing information. For example, the user equipment 10 may receive (e.g., download) the communication node pairing information from a communication network (e.g., the Internet). The communication node pairing information may include communication node identifiers (e.g., node identification information), beam identifiers (e.g., beam identification information), beam status information (e.g., functional, or non-functional), and/or any other relevant information (e.g., timing, orbit, elevation) associated with multiple communication nodes (e.g. the primary communication node 102A and the secondary communication node 102B). In some embodiments, the user equipment 10 may send location information (e.g., current location, estimated future location) of the user equipment 10 to the communication network, such that the received communication node pairing information may exclude certain information that is not related to the location information. In some embodiments, the communication node pairing information may be updated based on a predetermined frequency or cycle. For instance, the user equipment 10 may connect to the communication network periodically (e.g., on a daily basis, a weekly basis, after any suitable number of days or weeks, and so on) to download latest communication node pairing information. The user equipment 10 may store the communication node pairing information in the memory 14 or the storage 16 (e.g., in the form of a database.

As mentioned previously, the user equipment 10 may transmit different signals at different communication cycles. With this in mind, at block 304, the user equipment 10 synchronizes to a serving communication node (e.g., the primary communication node 102A) for signal transmission and reception at cycle N (N may be 1, 2, 3, 5, 10, 100, or any other suitable number). For example, after the synchronization, the user equipment 10 may receive a downlink signal from the serving communication node and decode a preamble and broadcast interval of the downlink signal. The preamble may be referred to as a signal used in network communications to synchronize transmission timing between two or more systems and/or devices. The preamble may locate at a beginning section of the downlink signal. The broadcast interval may be subsequent to the preamble in the downlink signal. The broadcast interval may communication node information (e.g., position, orientation, and so on) that may be decoded by the user equipment 10. For example, the decoded broadcast interval may include orientation information (e.g., yaw information) associated with the serving communication node.

At block 306, the user equipment 10 determines a beam identifier associated with a reverse beam for cycle N+1. For example, the user equipment 10 may use the decoded broadcast interval of the downlink signal to obtain the yaw information of the serving communication node. The yaw information may be used to determine or calculate the beam identifier associated with the reverse beam for the cycle N+1. After determining the beam identifier associated with the reverse beam for the cycle N+1, at block 308, the user equipment 10 determines whether the reverse beam is non-functional or receives an indication that the reverse beam is non-functional. For example, the user equipment 10 may query the memory 14 (e.g., by searching the communication node pairing information) to determine whether the serving communication node has one or more non-functional reverse beams. If the serving communication node has one or more non-functional reverse beams, the user equipment 10 may compare beam identifiers associated with the one or more non-functional reverse beams to the beam identifier associated with the reverse beam for the cycle N+1 and determine whether the reverse beam for the cycle N+1 is non-functional.

If the beam identifier associated with the reverse beam for the cycle N+1 does not match or correlate to any beam identifiers associated with the one or more non-functional reverse beams, at block 310, the user equipment 10 sets a forward communication node identifier (FWD CN ID) and a reverse communication node identifier (REV CN ID) to the same. The notation of FWD CN ID is used to denote an identifier of a forward communication node (e.g., transmitting a downlink signal to the user equipment and the notation of REV CN ID is used to denote an identifier of a reserve communication node (e.g., receiving an uplink signal from the user equipment 10).

If the beam identifier associated with the reverse beam for the cycle N+1 matches or correlates to one of the beam identifiers associated with the one or more non-functional reverse beams, at block 312, the user equipment 10 determines whether a paired communication node (e.g. the secondary communication node 102B) is accessible or visible, or receive another indication that the paired communication node is accessible or visible. The user equipment 10 may identify the paired communication node based on the communication node pairing information stored in the memory 14. For example, the communication node pairing information may indicate (e.g., using a communication node identifier) the paired communication node that is preset or predetermined to be paired with the serving communication node. The user equipment may determine whether the paired communication node is accessible based on certain characteristics (e.g., quality, power) of signals received from the paired communication node. For example, the user equipment may receive a signal transmitted from the paired communication node and determine that the signal quality or power exceeds a threshold, such that data carried by the signal may be retrieved (e.g., within an acceptable or threshold amount of errors). The user equipment 10 may determine whether the paired communication node is visible based on a relative positioning (e.g., an elevation angle) between the user equipment 10 and the paired communication node. a transmitted signal is received with a signal quality or power that exceeds a threshold, such that the data may be retrieved (within an acceptable or threshold amount of error)—or something like that. For example, if the paired communication node is not above an elevation threshold (e.g., 15 degrees), the user equipment 10 may determine that the paired communication node is not accessible or visible. Accordingly, at block 314, the user equipment 10 sets the reverse communication node identifier (REV CN ID) to “INVALID”.

On the contrary, if the paired communication node is above the elevation threshold (e.g., 15 degrees), the user equipment 10 may determine that the paired communication node is accessible or visible. Accordingly, at block 316, the user equipment 10 sets the reverse communication node identifier (REV CN ID) to the same identifier as the paired communication node. The user equipment 10 may also set the forward communication node identifier (FWD CN ID) to the same identifier as the serving communication node.

Additionally, in the cycle N, the user equipment 10 may periodically compute a time delay and a frequency shift (e.g., Doppler shift) for the cycle N+1. For example, a threshold duration of time (e.g., milliseconds (ms) or less, 60 ms or less, 90 ms or less, 120 ms or less, and so on) prior to the start of the cycle N+1, the user equipment 10 may determine the time delay and frequency shift to be used for the N+1 cycle based on the reverse communication node identifier (REV CN ID). At block 318, the user equipment determines whether the reverse communication node identifier (REV CN ID) is the same as the forward communication node identifier (FWD CN ID) or set to “INVALID”.

If the forward communication node identifier (FWD CN ID) is the same as the reverse communication node identifier (REV CN ID), or the reverse communication node identifier (REV CN ID) is set to “INVALID,” at block 320, the user equipment 10 uses the serving communication node, denoted as a forward communication node (FWD CN), for signal transmission and reception. In case of an “INVALID” reverse communication node identifier (REV CN ID), the user equipment 10 may use a different reverse beam of the serving communication node for signal reception (e.g., receiving an uplink signal from the user equipment 10). The different reverse beam may include a reverse beam adjacent to the reverse beam determined as non-functional.

If the forward communication node identifier (FWD CN ID) is different from the reverse communication node identifier (REV CN ID), and the reverse communication node identifier (REV CN ID) is set to “VALID”, at block 322, the user equipment 10 uses the forward communication node for signal transmission, and the paired communication node, denoted as a reverse communication node (REV CN), for signal reception. The user equipment 10 may adopt the time delay and frequency shift for the paired communication node for the signal reception. In this manner, the method 300 enables using multi-beam coverage by multiple communication nodes to communicate with the user equipment 10. Accordingly, the user equipment 10 may operate with more reliable communications with the communication hub 104 by utilizing a second uplink beam of a second communication node 102 when a first uplink beam of a first communication node 102 is non-functional, therefore preventing or reducing a signal transmission failure, especially during certain emergency events (e.g., accidents, natural disasters).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. User equipment, comprising:
one or more antennas;
a transmitter coupled to the one or more antennas;
a receiver coupled to the one or more antennas; and
processing circuitry configured to
cause the receiver to receive communication node pairing information,
receive a first indication that an uplink beam of a primary communication node is non-functional based on the communication node pairing information,
receive a second indication that a secondary communication node is accessible based on the communication node pairing information and the first indication,
cause the transmitter to transmit transmission signals to the secondary communication node, and
cause the receiver to receive reception signals from the primary communication node.

2. The user equipment of claim 1, wherein the communication node pairing information comprises communication node identification information associated with the primary communication node and the secondary communication node and beam identification information associated a plurality of uplink beams comprising the uplink beam of the primary communication node.

3. The user equipment of claim 1, wherein the receiver is configured to receive the communication node pairing information when the user equipment is communicatively coupled to a communication network.

4. The user equipment of claim 3, wherein the receiver is configured to receive updates from the communication network based on a time interval.

5. The user equipment of claim 1, wherein the processing circuitry is configured to cause the receiver to receive a downlink signal from the primary communication node in a communication cycle, the downlink signal comprising a preamble and a broadcast interval.

6. The user equipment of claim 5, wherein the processing circuitry is configured to decode the preamble and the broadcast interval of the downlink signal in the communication cycle, the broadcast interval comprising yaw information associated with the primary communication node.

7. The user equipment of claim 6, wherein the processing circuitry is configured to determine an identifier of the uplink beam for a different communication cycle subsequent to the communication cycle, and determine that the uplink beam of the primary communication node is non-functional based on the identifier of the uplink beam.

8. The user equipment of claim 1, wherein the processing circuitry is configured to receive a third indication of communication quality based on a relative positioning between the user equipment and the primary communication node or the secondary communication node.

9. The user equipment of claim 8, wherein the processing circuitry is configured to determine the relative positioning based on a location of the primary communication node or the secondary communication node, a location of the user equipment, and an orientation of the user equipment.

10. The user equipment of claim 9, wherein the relative positioning comprises an elevation angle of the secondary communication node relative to the user equipment.

11. A non-transitory, computer-readable medium comprising instructions that, when executed by processing circuitry of user equipment, cause the processing circuitry to:
receive communication node pairing information associated with a primary communication node paired with a secondary communication node;
synchronize with the primary communication node to receive reception signals from the primary communication node in a first communication cycle;
receive, for a second communication cycle, a first indication of that an uplink beam of the primary communication node is non-functional based on the communication node pairing information;
receive a second indication of whether the secondary communication node is accessible based on the communication node pairing information and the first indication; and
synchronize with the secondary communication node to transmit transmission signals to the secondary communication node based on the second indication in the second communication cycle.

12. The non-transitory, computer-readable medium of claim 11, wherein the communication node pairing information comprises a first communication node identifier associated with the primary communication node, a first set of beam identifiers associated with a first set of beams emitted by the primary communication node, a second communication node identifier associated with the secondary communication node, a second set of beam identifiers associated with a second set of beams emitted by the secondary communication node, and beam status information comprising one or more of the first set of beam identifiers corresponding to one or more non-functional uplink beams of the first set of beams.

13. The non-transitory, computer-readable medium of claim 12, wherein the instructions cause the processing circuitry to synchronize with the primary communication node in the first communication cycle based on the first communication node identifier.

14. The non-transitory, computer-readable medium of claim 12, wherein the instructions cause the processing circuitry to synchronize with the secondary communication node in the second communication cycle based on the second communication node identifier.

15. The non-transitory, computer-readable medium of claim 12, wherein the instructions, when executed by the processing circuitry, cause the processing circuitry to:
determine a beam identifier associated with the uplink beam of the primary communication node; and
determine a match between the beam identifier and the one or more of the first set of beam identifiers corresponding to one or more non-functional uplink beams of the first set of beams.

16. The non-transitory, computer-readable medium of claim 11, wherein the second communication cycle is subsequent to the first communication cycle.

17. An electronic device, comprising:
a transceiver; and
processing circuitry communicatively coupled to the transceiver and configured to
receive communication node pairing information associated with a primary communication node paired with a secondary communication node,
receive a location of the electronic device,
cause the transceiver to synchronize with the primary communication node to receive reception signals from the primary communication node for a first communication cycle,
receive a beam identifier corresponding to an uplink beam of the primary communication node based on the reception signals,
receive a first indication that the uplink beam of the primary communication node is non-functional based on the beam identifier and the communication node pairing information,
receive a second indication that the secondary communication node is accessible based on the communication node pairing information and the location of the electronic device based on the first indication, and
cause the transceiver to synchronize with the secondary communication node for a second communication cycle to transmit transmission signals to the secondary communication node based on the second indication.

18. The electronic device of claim 17, wherein the processing circuitry is configured to receive the communication node pairing information in a configuration process prior to the first communication cycle, the configuration process comprising pairing the primary communication node with the secondary communication node.

19. The electronic device of claim 18, wherein the processing circuitry is configured to
decode a preamble and a broadcast interval of the reception signals to obtain yaw information associated with the primary communication node, and
determine the beam identifier corresponding to the uplink beam of the primary communication node based on the yaw information.

20. The electronic device of claim 18, wherein the processing circuitry is configured to
determine a communication hub identifier associated with the secondary communication node based on the communication node pairing information,
determine a time delay and a frequency shift, and
cause the transceiver to transmit the transmission signals to the secondary communication node based on the time delay and the frequency shift.
